(19) United States
(12) Patent Application Publication
(10) Pub. No.: US 2026/0338968 A1
(43) Pub. Date: Oct. 29, 2026

(54) METHOD AND APPARATUS FOR DETERMINING ATTRIBUTES OF A SOURCE OF RADIATION

(71) Applicant: University of Lancaster, Lancaster (GB)

(72) Inventors: Malcolm John Joyce, Lancaster (GB); Soraia Sofia Clareu Elisio, Lancaster (GB)

(21) Appl. No.: 19/114,879

(22) PCT Filed: Sep. 29, 2023
(86) PCT No.: PCT/GB2023/052523

§ 371 Date: Mar. 25, 2025

(30) Foreign Application Priority Data
Sep. 29, 2022 (GB) 2214321.8

(51) Int. Cl. G01T 1/169; G01T 1/167

(52) U.S. Cl. CPC G01T 1/169; G01T 1/167

(57) ABSTRACT

Embodiments of the present invention provide a computer-implemented method of determining a location of a source (210) of radiation within a medium (200), the method comprising determining an indication of energy distribution of ionizing radiation incident upon a scintillation detector (320) at each of a plurality of locations of the detector within the medium, calibrating (630) one of a plurality first models to the indication of energy distribution of ionizing radiation determined at each of the plurality of locations within the medium (200), wherein each first model comprises a first portion representative of a photopeak of ionizing radiation from a first radioactive source, to determine a photopeak portion of the energy distribution at each respective location, and calibrating (920) a second model comprising an asymmetric function to the photopeak portion of the energy distribution at the plurality of locations to determine the location of the source (210) of radiation within the medium (200).

Embodiments of the present invention relate to methods and apparatus for determining one or more attributes of a source of radiation. In particular, some embodiments of the present invention relate to methods and apparatus for determining a location of a source of radiation.

### BACKGROUND

It is sometimes desired to determine one or more attributes of a source of radiation, such as a location of a source of radiation within a medium. The source of radiation may be naturally occurring, such as natural uranium in exploration and mining, or to assess radioactive contamination which acts as a source of radiation. The medium may be the ground, where a borehole is made and a radiation detector inserted into the borehole to measure ionising radiation within the borehole to assess ground contamination e.g. at sites contaminated with radioactivity. However, accurate measurement of such ionising radiation is difficult for a variety of reasons. It may be problematic to use a radiation detector in these environments for long periods of time due to environmental conditions e.g. water, ice etc. Furthermore, known radiation detection systems may output a dose value indicative of the ionising radiation, but it will be appreciated that dose estimation is difficult to determine. Furthermore, from such results it is difficult to determine the location of the source of radiation such as a depth of the source within the ground.

It is desired to determine allocation of a source of radiation within a medium, such as the ground, with increased accuracy.

It is an object of embodiments of the invention to at least mitigate one or more of the problems of the prior art.

### SUMMARY OF THE INVENTION

According to an aspect of the present invention, there is provided a computer-implemented method of determining a location of a source of radiation within a medium, the method comprising receiving data indicative of an indication of energy distribution of ionizing radiation incident upon a scintillation detector at each of a plurality of locations of the detector within the medium, and calibrating one of a plurality models to the indication of the energy distribution of ionizing radiation determined at each of the plurality of locations within the medium, wherein each model comprises a first part representative of a photopeak of ionizing radiation.

According to an aspect of the present invention, there is provided a computer-implemented method of determining a location of a source of radiation within a medium, the method comprising determining an indication of the energy distribution of ionizing radiation incident upon a scintillation detector at each of a plurality of locations of the detector within the medium, calibrating one of a plurality models to the indication of the energy distribution of ionizing radiation determined at each of the plurality of locations within the medium, wherein each model comprises a first part representative of a photopeak of ionizing radiation from a first radioactive source, and determining the location of the source of radiation within the medium in dependence on an asymmetric function representative of one or more attributes of the first part of each of the plurality of models.

According to another aspect of the present invention there is provided an apparatus for determining a location of a source of radiation within a medium, comprising a detector for detecting ionising radiation and a signal processing module co-located with the detector. The detector and signal processing module may be arranged to be inserted into the medium. The signal processing module may be arranged to output digital signals indicative of a count of radiation detections made by the detector.

According to another aspect of the present invention there is provided computer software which, when executed by a computer, is arranged to perform a method according to an embodiment of the invention. The computer software may be stored on a computer readable medium. The computer software may be tangibly stored on the computer readable medium.

### BRIEF DESCRIPTION OF THE DRAWINGS

Embodiments of the invention will now be described by way of example only, with reference to the accompanying figures, in which:

FIG. 1 shows an illustration of a medium;

FIG. 2 shows an illustration of a ground borehole and a source of radiation;

FIG. 3 shows an illustration of a system according to an embodiment of the invention;

FIG. 4 shows a schematic illustration of a system according to an embodiment of the invention; and

FIG. 5 illustrates an indication of energy distribution of ionizing radiation incident upon a detector according to an embodiment of the present invention;

FIG. 6 illustrates a method according to an embodiment of the invention;

FIG. 7 illustrates components of a model and recorded data according to an embodiment of the invention;

FIG. 8 illustrates indications of ionizing radiation at a detector against depth;

FIG. 9 shows a method according to an embodiment of the invention; and

FIG. 10 illustrates a plot of a model according to an embodiment of the invention.

### DETAILED DESCRIPTION OF EMBODIMENTS OF THE INVENTION

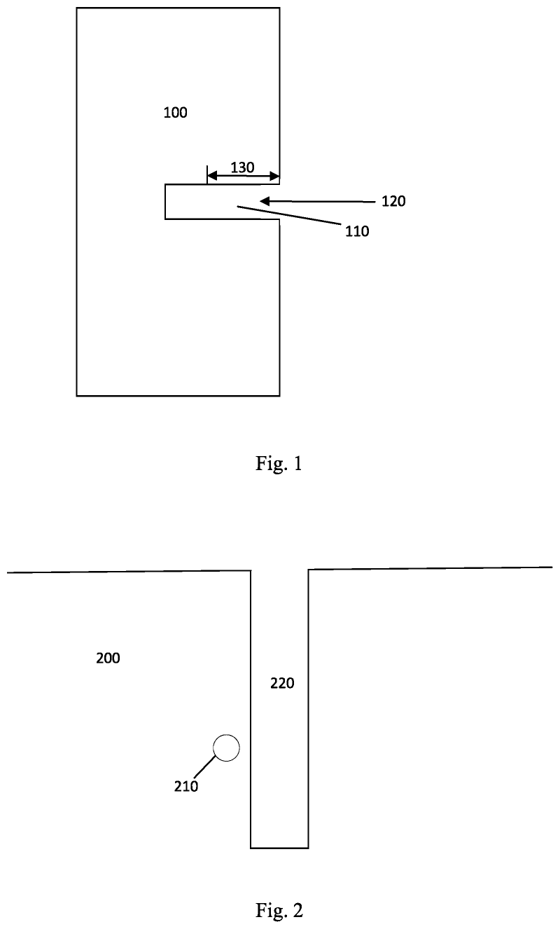

Embodiments of the present invention relate to determining a location of a source of radiation within a medium 100. FIG. 1 illustrates a medium 100 which may be substantially solid material within which a source of radiation is located. In order to investigate a location of the source of radiation within the medium 100 a borehole 110 or blind aperture 110 has been formed which extends into the medium 100. In the illustrated example the borehole 110 extends horizontally a distance into the medium 100. The borehole 110 is used in embodiments of the invention to determine a distance 130 into the medium 100, as indicated by arrow 120, at which the source of radiation is located. Thus the location of the source of radiation may be determined as a distance from a reference location, such as an outer surface of the medium 100 in some embodiments. The borehole 110 allows a detector to be inserted into the medium 100 to detect ionizing radiation emitted from, or caused by, the source of radiation as will be explained.

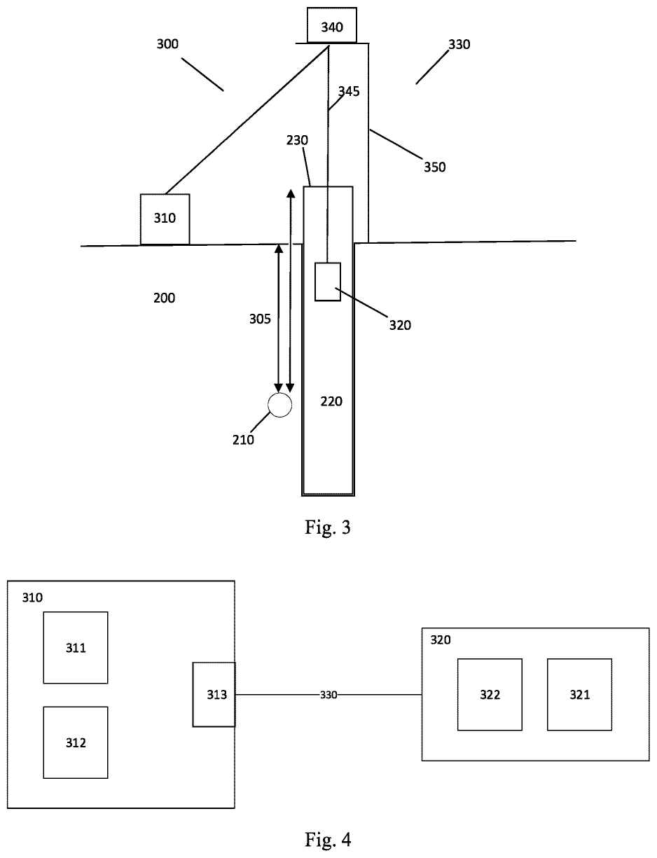

In some embodiments the medium may be the ground 200 as illustrated in FIG. 2. A source of radiation 210 is located at a depth into the ground 200. In order to investigate the location of the source of radiation 210 a borehole 220 is formed, such as drilled, into the ground 200. The borehole 220 is a generally vertical blind aperture which extends downward into the ground 220. The borehole 220 may also be known as a well or monitoring well 220. The borehole 220 allows for a detector to be inserted, or lowered, into the ground 200 as will be explained. The location of the source of radiation 210 may be determined as a depth of the source of radiation 210 into the ground 200. As illustrated in FIG. 3, in some embodiments a sleeve or blind-tube 230 may be inserted into the borehole 220. The blind tube 230 may be made of metal and may also extend upward from an upper surface of the ground by a distance, as illustrated. The blind-tube 230 may be a tube which is sealed to a blind end of the borehole 220 or may itself have a blind end. The blind-tube may provide structural strength to walls of the borehole 220.

FIG. 3 shows an illustration of a system 300 according to an embodiment of the invention arranged in use in relation to the ground 200 and borehole 220 of FIG. 2.

The system 300 comprises a control unit 310 and a detector 320 which is communicably coupled to the control unit 310. The detector 320 may be in wireless or wired communication with the control unit 310. In some embodiments, the detector 320 communicates with the control unit 310 via a wired interface which advantageously provides improved communication, particularly when the detector 320 is located at depth within the borehole 220 which may hamper wireless signals. Furthermore, in some embodiments, the wired interface may be a network communication protocol, such as an IP-based communication protocol. In one embodiment the wired interface may be Ethernet. Such network communication protocols may provide improved long-distance communication over, for example, USB communication. As will be explained, the detector 320 may comprise signal processing functionality to locally process and analyse signals from the detector 320. The detector 320 may be connected to a flexible support member such as a cable 345, for example, a metal cable, or chain from which the detector 320 may be suspended within the borehole 220. The system 300 is arranged to selectively lower and raise the detector 320 within the borehole 220 as will be explained.

The system 300 comprises an apparatus 330 for controllably inserting the detector 320 into the medium 200. In the illustrated example the apparatus is arranged to controllably suspend the detector 320 at a determinable or known depth within the borehole 220. The apparatus 330 may comprise a winch 340 which is arranged to withdraw or extend the flexible support member 345 from which the detector 320 is suspended. In the illustrated example the winch 340 is mounted upon a support frame 350 such that it is generally located above the borehole 220 in use. However it will be appreciated that other arrangements may be envisaged. For example, the winch 340 may not be located upon the support frame 350. In another embodiment the winch 340 may be located at a lower level, such as ground level, and a pulley or guide may be located upon the support frame 350 over which the flexible support member 345 runs to allow a change of direction. The winch 340 is controlled by the control unit 310 to controllably raise and lower the detector 320 within the borehole 220. The control unit 310 may instruct the winch 340 to raise or lower the detector 220 by an instructed distance e.g. 0.1 m, 0.2 m etc. In other embodiments, the control unit 310 may instruct the winch 340 to raise or lower the detector 320 until instructed to stop. In such embodiments, the system 300 may comprise a measurement unit (not shown) for determining an amount or distance by which the detector 320 has been raised or lowered, such as by recording a passing of the flexible support member 345, and reporting the amount or distance to the control unit 310. In this way the control unit 310 is arranged to raise or lower the detector 320 by known amounts or distances within the borehole 220. The control unit 310 controls the system to enable recording of ionizing radiation at a plurality of known depths within the borehole 220. A calibration step may be utilised to determine when the detector 320 is initially positioned at a reference location. The reference location may correspond to a top of the blind tube 230, level with an upper surface of the ground i.e. ground level, or other selected reference location. The location of the source of radiation 210 may be determined as a distance or depth 305 from the reference location which in the illustration of FIG. 3 is ground level with it being appreciated that this is not restrictive.

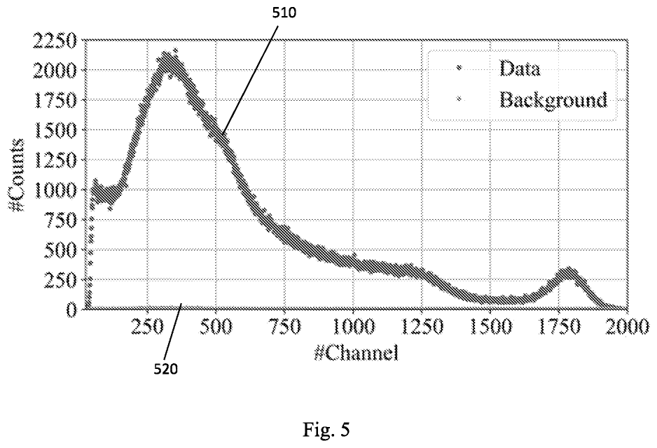

FIG. 4 schematically illustrates a portion of the system 300 comprising the control unit 310 and detector 320 according to an embodiment of the invention. The detector 320 comprises a radiation detector 321 for detecting ionizing radiation. The detector may be a scintillator 321 such as in the form of a scintillation crystal. The scintillation crystal may be cerium bromide (CeBr₃) in some embodiments. The detector 320 may comprise a signal processing module 322 for processing signals from the scintillator 321. The detector 320 may record counts each corresponding to an interaction of ionizing radiation with the detector in one of a plurality of channels each corresponding to energy. In this way an energy distribution of ionizing radiation interacting with the detector may be determined. As noted above, in some embodiments the detector 320 and the control unit 310 communicate over a wired interface 330 such as Ethernet. A detector 321 may be obtained from Scionix® of the Netherlands. The detector 320 may comprise a photomultiplier and preamplifier to process signals from the scintillation crystal. The signal processing module 322 may be arranged to perform pulse height analysis on signals output by the detector 321. The signal processing module 322 may be arranged to output data indicative of a number of counts of ionizing radiation detected by the detector in each of a plurality of channels corresponding to respective energy bands over a period of time. An example is illustrated in FIG. 5. FIG. 5 illustrates a number of counts recoded during a period of 1 hour when the detector 320 was exposed to a ¹³⁷Cs source, indicated with numeral 510, and without a source of radiation i.e. background radiation detection indicated with numeral 520. Thus it can be appreciated that the number of counts in each channel is indicative of the number of ionizing radiation detections within a respective energy band or range. The signal processing module 322 may be arranged to receive analogue electrical signals output by the detector 320 and to output a digital signal indicative of the data indicative of the number of counts of ionizing radiation detected by the detector 321, thereby digitising the analogue data. Having the signal processing module 322 co-located with the detector 321 i.e. physically close there-to avoids degradation of the signals output by the detector 321.

The control unit 310 may comprise a processor 311 and memory 312 for storing data therein. The memory 312 may store computer readable code or instructions for execution by the processor 311. The control unit 310 may further comprise a communication module 313 for receiving data from the detector 320, such as via the wired interface 330. The communication module 313 may be a network interface, such as an Ethernet network interface. The received data may be stored in the memory 312 of the control unit 310. The communication module 313 may be arranged to output signals to control positioning of the detector 320 within the borehole 220, such as to output signals to control the winch 340 and/or to receive data indicative of the position of the detector 320, such as indicative of a distance by which the detector 320 has been raised or lowered within the borehole 320.

In some situations, the source of radiation 210 may comprise a plurality of radionuclides. That is, the source of radiation may comprise a plurality of respective sources of radiation of different types. For example, the source of radiation may comprise one or both of ¹³⁷Cs and ⁹⁰Sr. ¹³⁷Cs emits gamma (Y) rays with an energy of around 0.6617 MeV which may be detected directly by the detector 321 since they are able to travel a sufficient distance within the medium 200, in some embodiments, penetrate a wall of the blind tube 230, and a body of the detector 321. ⁹⁰Sr emits β particles with an energy of 0.546 MeV and decays to ⁹⁰Y which also emits β particles with an energy of 2.28 MeV. Due to the short range of β particles these are unlikely to be directly detected by the detector 321. However, produced bremsstrahlung photons caused by the β particles may be detected by the detector 321. Thus the detector 321 may receive ionizing radiation caused by a plurality of sources of radiation, particularly a first source and a second source of radiation. Embodiments of the present invention utilise a model comprising respective components for the first and second sources, as will be explained.

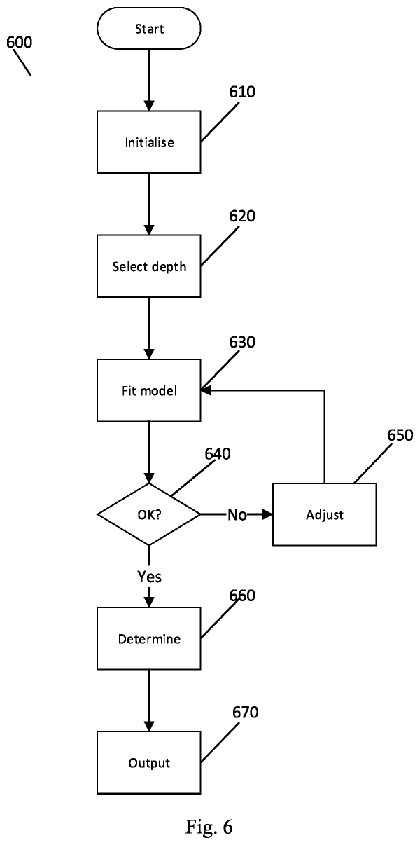

FIG. 6 illustrates a method 600 according to an embodiment of the invention. Computer readable instructions representative of the method 600 may be stored in the memory 312 and executed by the processor 311. Thus the system 300 may implement an embodiment of the method 600. The method 600 is a method of calibrating a model to an indication of an energy distribution of ionizing radiation determined at a location within a medium 200. The model ƒ₁ comprises a first part or portion representative of a photopeak of ionizing radiation from a first source of radiation. The first source of radiation may be ¹³⁷Cs and ionizing radiation such as gamma rays emitted therefrom. The model ƒ₁ comprises a second part or portion representative of ionizing radiation caused by a second source of radiation.

Prior to execution of the method 600, the system 300 of FIGS. 3 and 4 is used to record data indicative of an energy distribution of ionizing radiation at one or more locations within the medium 200. For example, in relation to the borehole 220 illustrated in FIG. 3, the system 300 is used to record the data with the detector 320 at one or more depths in the ground 200 i.e. down the borehole 220. Each depth may be indicated with a respective indicator i wherein i=1, 2, 3 etc. For example, i=1 may be 0.1 m, i=2 may be 0.2 m etc, where the distance may be measured from the reference location such as the ground surface or the top of the blind tube 230. Thus increasing values of i indicate increasing depth into the ground 200 in some embodiments. The detector 320 is located at each depth for a period of time, such as 1 hour for example, although other durations of time may be used. The data for each depth is indicative of a number of counts of ionizing radiation recorded in each of a plurality of channels, wherein each channel corresponds to an energy band, thus being indicative of the energy distribution. An example of the data recorded at one depth is shown in FIG. 5. When the system 300 is used to record data at the plurality of depths, data are recorded for each of the plurality of i depths indicative of the energy distribution at each particular depth or location within the medium. Thus a data set as shown in FIG. 5 is recorded for each depth. The data for each of the plurality of depths may be stored in the memory 312 of the control unit 310. The memory may store a plurality of data sets as shown in FIG. 5 each corresponding to a respective depth down the borehole 220.

The method 600 illustrated in FIG. 6 calibrates a model to each indication of the energy distribution of ionizing radiation determined at a respective location within the medium. That is, for each depth, a model is calibrated to the data for that respective depth. When the system 300 is used to record three sets of data e.g. at depths i=1, 2, 3, the method 600 may be performed three times to determine one or more attributes of the data for each depth. As will be explained, in block 620 a depth i is selected by obtaining the appropriate data recorded with the detector 320 at that particular depth. Referring to FIG. 6, the method 600 comprises a block 610 of initialising one or more variables used in the method 600.

In block 610 a region of interest (ROI) of the energy spectrum is selected. The ROI is defined between lower L and upper U energy bounds. The ROI is intended to define, or capture, an energy region corresponding to a photopeak of ionizing radiation from the first radioactive source, such as ¹³⁷Cs, as will be discussed further below. The lower and upper energy bounds may be defined by channel number in some embodiments.

The lower energy bound may be defined by L and the upper energy bound by U, where L and U may be channel numbers or energy values. Thus ROI[L, U] defines a portion of the energy spectrum as the region of interest. In block 610 one or more or more other variables may be initialised, wherein a subscript 0 is indicative of the initial value, such as one or more of A₀, B₀, C₀, T₀, σ₀, μ₀, b₀, wherein:
A is amplitude of a Gaussian peak;
B is a factor such that AB is an amplitude of a step component;
C is a factor such that AC is an amplitude of a tail component;
T is a dimensionless parameter that scales a rate at which the tail component falls;
σ is standard deviation of the Gaussian peak;
μ is centroid of the Gaussian peak; and
b is a constant, which may be small and thus could be omitted in some embodiments.

Initial values for U and L were chosen observing a typical obtained spectrum. L may be a channel number in a position to the right of the Compton edge shoulder (before a number of detection counts against channel number starts to curve). U may be a channel number in a position to the right of the photopeak when the detection counts are equivalent to, or similar in value to, background noise.

As noted above, in block 620 data for a depth I is selected, such as i=1 in an example. In further iterations of the method other depths i.e. i=2, 3 . . . may be selected until all depths have been considered by the method 600.

In block 630 a model ƒ₁ is calibrated or fitted to the data representative of the indication of energy distribution of ionizing radiation determined at the selected depth. As explained below, the model comprises a first part representative of a photopeak of ionizing radiation from the first radioactive source such as ¹³⁷Cs. In some embodiments, the model ƒ₁ comprises a second part representative of ionizing radiation caused by a second radioactive source, such as ⁹⁰Sr.

The model ƒ₁ may be of the form defined in Equation 1 of:

ƒ₁=G(x)+S(x)+T(x)+b Equation 1

wherein x is indicative of channel number or energy. A first part G(x), as defined in Equation 2, is representative of the photopeak of ionizing radiation:

$$G ( x ) = {Ae}^{- \frac{{( x - μ )}^{2}}{2 {σ}^{2}}} \qquad Equation 2$$

It will be appreciated that the photopeak is a region of the energy distribution spectrum caused by complete photelectric absorption of gamma rays by the scintillator 321 of the detector 320. G(x) is the Gaussian peak function, which may represent a full-energy line, A is the amplitude of the Gaussian function, μ its centroid and σ the standard deviation.

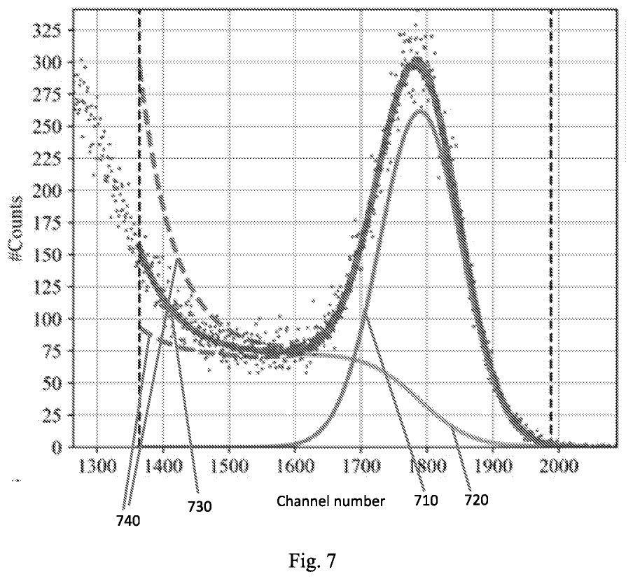

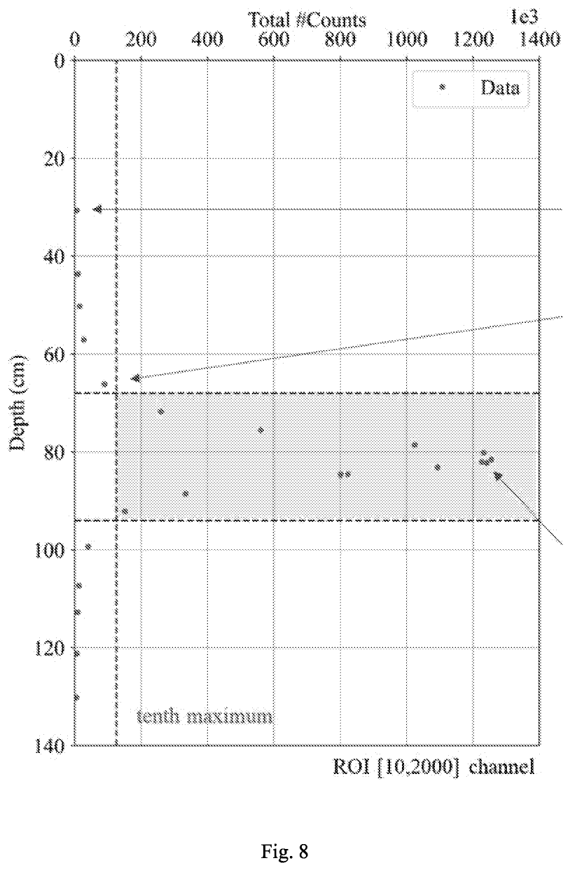

FIG. 7 is a plot of detector data (dots) along with a curve 710 representing the photopeak G(x). FIG. 8 is an illustration of a total number of counts against a depth of the detector 320 in the medium 200.

In some embodiments, the model ƒ₁ comprises a second part which may be indicative of the second source of radiation. The second part may comprise one or both of second and third functions, as defined by Equations 3 and 4, respectively.

$$S ( x ) = AB erfc ( \frac{x - μ}{σ \sqrt{2}} ) \qquad Equation 3$$

$$T ( x ) = {ACe}^{\frac{x - μ}{T σ}} erfc ( \frac{x - μ}{σ \sqrt{2}} + \frac{1}{T \sqrt{2}} ) \qquad Equation 4$$

S(x) is a step function which represents a step discontinuity that may appear in the continuum below the Gaussian peak towards its low energy side. S(x) may be produced by detection of Compton scattering photons into the detector 320 from surrounding materials, folded with Gaussian noise. B is the step function amplitude expressed as a fraction of A amplitude of G(x), and erfc(x) is the complementary error function.

T(x) is a tail function which represents an exponential-type discontinuity that may appear in the continuum below the Gaussian peak towards its low energy side. T(x) may represent the effect of incomplete charge collection in the detector volume, which is modelled by an exponential decaying distribution of counts below the peak, folded with Gaussian noise. C is the amplitude of T(x) expressed as a fraction of A, and T the slope of the exponential. In some embodiments b is a constant representing residual background counts.

The plot 720 in FIG. 7 represents S(x)+T(x)+b. The second part of the model formed by Equations 3 and 4 represent secondary radiation causing detection events at the detector 320, where events from ¹³⁷Cs are considered to be primary radiation. The secondary radiation is bremsstrahlung from ⁹⁰Sr and ⁹⁰Y, scattered photons from ¹³⁷Cs, natural radiation etc. The components S(x), T(x) and b of Equation 1 represent the secondary radiation as indicated by 720 in FIG. 7.

The generated ⁹⁰Sr and/or ⁹⁰Y bremsstrahlung photons that may reach the detector 320 contribute to the measured spectrum and its individual spectrum extends to an energy equal to the maximum beta particle energy. The significant yield is confined to low energies (lower than the ROI), but because the bremsstrahlung spectrum is continuous up until the maximum stated it adds some counts in higher energies as well (in the ROI).

In FIG. 7 the model ƒ₁ corresponding to a combination of the first and second parts discussed above is indicated by line 730 with a 1 sigma range indicated by dashed lines 740.

The model ƒ₁ is fitted to the data for the selected depth i.e. depth i in block 630. The model may be fitted using an appropriate fitting algorithm, such as a least-squares minimisation algorithm. The least-squares fitting algorithm may be a Lenvenberg-Marquardt algorithm to find a local minimum, although others may be used. The fitting algorithm aims to find values of unconstrained parameters, which may include one or more of A, B, C, T, σ, μ and b in some embodiments, which fit the function ƒ₁ to the data at the selected depth i. The fitting algorithm may start in an initial iteration with the initial values determined in block 610 i.e. A₀ etc. In some embodiments, a fitting algorithm scipy.optimize.curve_fit( ) in Python may be used, although other algorithms are available. The fitting algorithm, such as Scipy.optimize.curve_fit( ) determines optimal values for the unconstrained parameters to fit the data i.e. dots in FIG. 7.

In block 640 it is determined or checked whether any errors occurred with the fitting process. If one or more errors occurred, such as the fitting not being able to find optimal parameters, one or more adjustments or changes are made in block 650. After the one or more adjustments, bock 630 is repeated. In block 650 in one embodiment the ROI may be adjusted, such as one or both of changed in location within the energy spectrum or size. In one embodiment a value of U is changed in block 650. The value of U may be changed by reducing U in value i.e. to a lower energy. For example, block 650 may comprise U=U−1 i.e. reducing by one channel the value of the upper bound of the ROI, U.

In block 650 it may be checked in some embodiments whether U<μ i.e. whether the upper bound is less than the value of the centroid of the Gaussian peak. If so, then the method 600 may end. If, however, no error exists and optimised parameters are determined block 630, the method moves to block 660.

In block 660 one or more attributes associated with the photopeak are calculated. As discussed above, the photopeak is defined in the above model ƒ₁ by G(x). In some embodiments, the one or more attributes are an area Nᵢ under the Gaussian peak for the selected depth i, as defined by Equation 5 below. Nᵢ may be a number of counts corresponding to the photopeak.

$${N}_{i} = {\int }_{{μ}_{i} - n}^{{μ}_{i} + n} {G}_{i} ( x ) dx \qquad Equation 5$$

Where n may assume a predetermined value which may be indicative of a predetermined energy width or a number of channels in some embodiments. The value of Nᵢ is indicative of a level of radioactivity at each depth corresponding to the photopeak of the first source of radiation.

An uncertainty u associated with the area under the Gaussian peak may be defined by Equation 6.

μNᵢ=\sqrt{Nᵢ} Equation 6

In some embodiment

$${χ}_{R}^{2}$$

(Chi-Square test of independence) may be calculated using methods of which the skilled person will be aware to determine an independence of the variables.

The method 600 may be repeated for each depth i at which a data set is determined. For example, the method 600 may be repeated for each of the four depths in the example to determine a respective value of N for each i. Nis determined as a total number of counts corresponding to the photopeak.

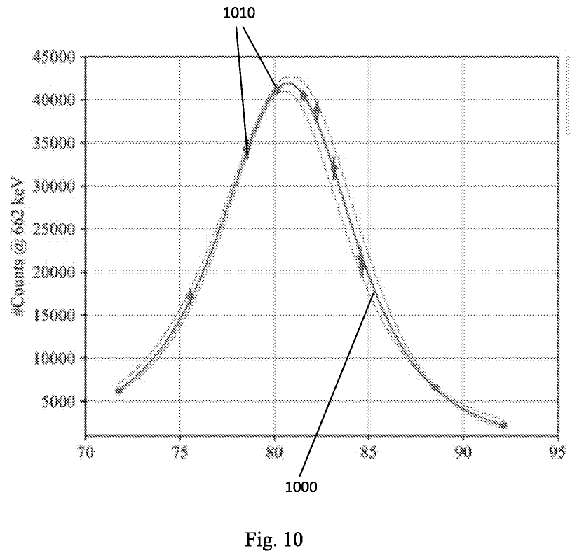

FIG. 10 illustrates a plot of Nᵢ as a value 1010 determined by the method 600 above for each depth (only two of which are labelled) for each of a number of depths against a source of radiation located at approximately 80 cm depth. Given the count value determined at each of the plurality of depths it is desired to determine the location of the source of radiation 210, such as the depth of the source of radiation within the medium 200.

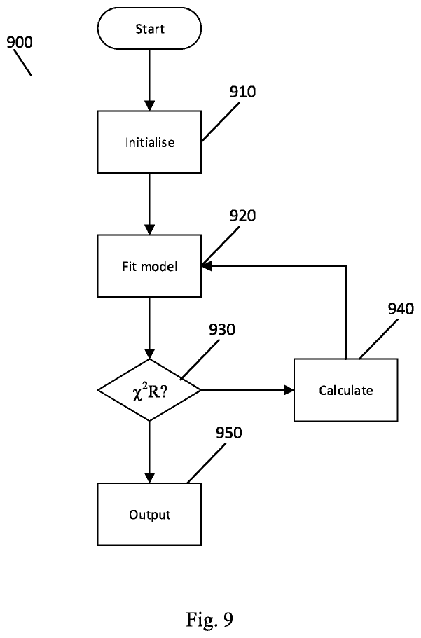

FIG. 9 illustrates a method 900 according to a further embodiment of the invention. Computer readable instructions representative of the method 900 may be stored in the memory 312 and executed by the processor 311. Thus the system 300 may implement an embodiment of the method 900. The method 900 is a method of determining a location of a source of radiation 210 within a medium 200. The method 900 utilises an output of the method 600 described above. The method 900 receives an indication of an output of the detector 320 corresponding to the photopeak of the first source of radiation at each of a plurality of depths within the medium 200. As described above, the photopeak is caused by ionizing radiation from the first source of radiation such as ¹³⁷Cs.

It has been determined that the location of the source of radiation 210 within the medium 200, such as the depth within the ground of the source 210, can be determined using a model ƒ₂ comprising an asymmetric function. The asymmetric function may be representative of one or more attributes of the first part of each of the plurality of models. The asymmetric function may be an asymmetric point spread function. Similar functions have been used for astrophysical problems. However the present inventors have surprisingly realised that such functions may be used in problems in the field of the present invention. The asymmetric function may be a Moffat function with a skew component. It is believed that such asymmetric functions are useful in borehole environments due to the blind end of the borehole causing the skew of the distribution.

In one embodiment of the invention, the model ƒ₂ comprises an asymmetric function of the form:

$${f}_{2} = {A [ 1 + \frac{{( x - μ )}^{2}}{{t ( x )}^{2}} ]}^{- β} \qquad Equation 7$$

$$t ( x ) = \frac{2 w}{1 + {e}^{γ ( x - {x}_{0} )}} \qquad Equation 8$$

Where:
A is an amplitude of the peak;
β is a width of tails of the peak;
x is a depth position of the detector;
μ is a centroid of the peak i.e. a depth of the source of radiation within the medium;
γ is a value indicative of skewness of the peak; and
w is indicative of a half-width-half-maximum of the peak.

In the method 900 illustrated in FIG. 9 block 910 comprises initialising values of unconstrained variables used in the method 900. Block 910 may comprise initialising values of one or more of A₀, B₀, μ₀, w₀, γ₀, wherein a subscript 0 is indicative of the initial value, which may be a predetermined or random initial value for example.

In block 910 an uncertainty of the plurality of values of N may be determined as:

μNᵢ=Nᵢ Equation 9

In block 920 the model ƒ₂ is fitted to the data for the plurality of depths i.e. the data received from method 600. The model ƒ₂ may be fitted using an appropriate fitting algorithm, such as a least-squares minimisation algorithm. The least-squares fitting algorithm may be a Lenvenberg-Marquardt algorithm to find a local minima, although others may be used. The fitting algorithm aims to find values of one or more of the unconstrained parameters discussed above which fit the function ƒ₂ to the data at the plurality of depths. The fitting algorithm may start in an initial iteration with the initial values determined in block 910 i.e. A₀ etc. In some embodiments, a fitting algorithm scipy.optimize.curve_fit( ) in Python may be used, although other algorithms are available. The fitting algorithm, such as Scipy.optimize.curve_fit( ) determines optimal values for the unconstrained parameters.

In block 920

$${χ}_{R}^{2}$$

may be calculated a test of independence using methods of which the skilled person will be aware. The method 900 progresses to block 950 in dependence on one or more conditions. In some embodiments, a predetermined number of iterations of block 940 may be performed. In other iterations the one or more conditions comprise a value or trend of

$${χ}_{R}^{2} .$$

In one embodiment, the method may progress to block 940 until the value of

$${χ}_{R}^{2}$$

begins to increase when the method 900 progresses to block 950.

In block 940 an uncertainty of

$${uN}_{eff} = \sqrt{( uD \frac{{df}_{2}}{dD} ) + {uN}^{2}} \qquad Equation 10$$

where uD is 0.2 cm, although other values may be selected as appropriate.

The above are provided back to a further iteration of block 920 for improved fitting of the model.

FIG. 10 illustrates the fitting of the model 1000 to the data 1010 from the method 600. As a result of blocks 920-940 attributes indicative of the source of radiation 210 are determined. The attributes include μ which is the inferred depth of the source of radiation 210 within the medium 200. Therefore, using the asymmetric function, a depth of the source of radiation within the medium 200 is determined. The depth may be output such as on a display screen to a user. However in some embodiments of the method a further block (not shown) is included of excavating or digging to, or a distance beyond, the depth of the source of radiation 210 in order to remove material forming the source of radiation. The system 300 may control excavation to the determined depth. For example, data indicative of the depth may be provided to a robotic excavator. Removed material may be removed and stored with appropriate safety precautions, such as being encased in a shielding material e.g. concrete or similar.

It will be appreciated that embodiments of the present invention may be used to determine the location of the source of radiation within the medium, such as the depth in the ground, of the source of radiation using a plurality of measurements of ionizing radiation at respective locations. In this way a convenient and safe method is provided for locating the source of radiation. For example, radioactive contamination into the ground may be located and removed using embodiments of the invention.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method of determining a location of a source of radiation within a medium, the method comprising:
determining an indication of energy distribution of ionizing radiation incident upon a scintillation detector at each of a plurality of locations of the detector within the medium;
calibrating one of a plurality first models to the indication of energy distribution of ionizing radiation determined at each of the plurality of locations within the medium, wherein each first model comprises a first portion representative of a photopeak of ionizing radiation from a first radioactive source, to determine a photopeak portion of the energy distribution at each respective location; and
calibrating a second model comprising an asymmetric function to the photopeak portion of the energy distribution at the plurality of locations to determine the location of the source of radiation within the medium.

2. The method of claim 1, wherein each of the plurality of first models comprises a second portion representative of ionizing radiation incident upon the scintillation detector caused by a second source of radiation.

3. The method of claim 2, wherein the second portion is further representative of background radiation incident upon the scintillation detector.

4. The method of claim 2, wherein the second portion is further representative of scattered radiation from the first source of radiation incident upon the scintillation detector.

5. The method of claim 2, wherein the second portion is representative of bremsstrahlung photons caused by the second source of radiation incident upon the scintillation detector.

6. The method of claim 1, wherein the first portion comprises a Gaussian distribution representative of the photopeak of ionizing radiation from the first radioactive source.

7. The method of claim 6, wherein the first portion G(x) is of a form:
$$G ( x ) = {Ae}^{- \frac{{( x - μ )}^{2}}{2 {σ}^{2}}}$$
wherein A is amplitude of a Gaussian peak, x is indicative of energy, μ is centroid of the Gaussian peak, and σ is standard deviation of the Gaussian peak.

8. The method of claim 2, wherein the second portion comprises a step function.

9. The method of claim 2, wherein the second portion comprises a tail function.

10. The method of claim 1, wherein calibrating one of the plurality first models comprises calibrating one or more variables associated with a Gaussian peak of the model to data indicative of the energy distribution of ionizing radiation at the respective location within the medium in dependence on a fitting algorithm; optionally the fitting algorithm is a least-squares minimisation algorithm.

11. The method of claim 1, wherein the asymmetric function is skewed towards greater detections of incident radiation at lower depth.

12. The method of claim 1, wherein the asymmetric function comprises a Moffat distribution.

13. The method of claim 1, wherein the asymmetric function represents a peak and is of a form:
$${f}_{2} = {A [ 1 + \frac{{( x - μ )}^{2}}{{t ( x )}^{2}} ]}^{- β}$$
$$t ( x ) = \frac{2 w}{1 + {e}^{γ ( x - {x}_{0} )}}$$
wherein A is an amplitude of the peak, β is a width of tails of the peak, x is a depth of the detector, μ is the location of the source of radiation within the medium, γ is a value indicative of skewness of the peak, w is indicative of a half-width-half-maximum of the peak.

14. (canceled)

15. The method of claim 1, wherein calibrating the second model comprises calibrating one or more variables associated with the asymmetric function to the photopeak portion of the energy distribution at the plurality of locations in dependence on a fitting algorithm; optionally the fitting algorithm is a least-squares minimisation algorithm.

16. The method of claim 1, comprising calibrating a plurality first models to respective indications of energy distributions of ionizing radiation determined to determine a photopeak portion of the energy distribution at each respective location within the medium.

17. The method of claim 1, wherein the first source of radiation comprises ¹³⁷Cs.

18. The method of claim 1, wherein the second source of radiation comprises ⁹⁰Sr.

19. The method of claim 1, comprising outputting an indication of the location of the source of radiation within the medium; optionally the indication is output on a display device.

20. The method of claim 1, comprising controlling an excavator to excavate to the location of the source of radiation.

21. An apparatus for determining a location of a source of radiation within a medium, the apparatus comprising:
an interface for receiving data indicative of an indication of energy distribution of ionizing radiation incident upon a scintillation detector at each of a plurality of locations of the detector within the medium;
a processor; and
a memory comprising instructions, which when executed by the processor, cause the processor to:
calibrate one of a plurality first models to the indication of energy distribution of ionizing radiation determined at each of the plurality of locations within the medium, wherein each model comprises a first portion representative of a photopeak of ionizing radiation from a first radioactive source, to determine a photopeak portion of the energy distribution at each respective location; and
calibrate a second model comprising an asymmetric function to the photopeak portion of the energy distribution at the plurality of locations to determine the location of the source of radiation within the medium.

22. A system comprising the apparatus of claim 21 and a scintillation detector arranged to, in use, provide an indication of energy distribution of ionizing radiation incident thereon.

23. The system of claim 22, comprising an actuator arranged to control a location of the scintillation detector within the medium in dependence on a control signal from the apparatus; optionally the actuator comprises a winch.

24. At least one non-transitory computer-readable medium encoded with instruction which, when executed by at least one processor of a system, cause the system to determine a location of a source of radiation within a medium at least in part by:
determining an indication of energy distribution of ionizing radiation incident upon a scintillation detector at each of a plurality of locations of the detector within the medium;
calibrating one of a plurality first models to the indication of energy distribution of ionizing radiation determined at each of the plurality of locations within the medium, wherein each first model comprises a first portion representative of a photopeak of ionizing radiation from a first radioactive source, to determine a photopeak portion of the energy distribution at each respective location; and
calibrating a second model comprising an asymmetric function to the photopeak portion of the energy distribution at the plurality of locations to determine the location of the source of radiation within the medium.
